(19) United States
(12) Patent Application Publication
(10) Pub. No.: US 2013/0290262 A1
(43) Pub. Date: Oct. 31, 2013

(54) INFORMATION PROCESSING DEVICE, COMPUTER-READABLE RECORDING MEDIUM STORING PROGRAM FOR GENERATING SNAPSHOT, AND METHOD THEREFORE

(71) Applicant: FUJITSU LIMITED, Kawasaki-shi (JP)

(72) Inventors: Katsuyoshi Yazawa, Sakado (JP); Yuuki URAGOU, Kawasaki (JP); Yasuaki CHIYOKAWA, Kawasaki (JP)

(73) Assignee: FUJITSU LIMITED, Kawasaki-shi (JP)

(21) Appl. No.: 13/871,238

(22) Filed: Apr. 26, 2013

(30) Foreign Application Priority Data
Apr. 27, 2012 (JP) 2012-103530

(51) Int. Cl. G06F 17/30

(52) U.S. Cl. CPC G06F 17/30289
USPC 707/649

(57) ABSTRACT

An information processing device includes a storage unit which stores information, and a processor which performs processes including generating a first snapshot of the information, and storing first pointer information indicating a storage position of the information associated with the first snapshot in the storage unit, monitoring completion of a writing process on the information when the first snapshot is generated during the writing process, generating a second snapshot of the information when the completion of the writing process is detected, and storing, in the storage unit, second pointer information indicating a storage position of the information associated with the second snapshot; and replacing the first pointer information stored in the storage unit with the second pointer information.

### CROSS-REFERENCE TO RELATED APPLICATION

This application is based upon and claims the benefit of priority of the prior Japanese Patent Application No. 2012-103530, filed on Apr. 27, 2012, the entire contents of which are incorporated herein by reference.

### FIELD

The embodiments discussed herein are related to the technology for a snapshot.

### BACKGROUND

A snapshot is a technique of generating in a moment a copy of a data image at a specified time point as a technique to periodically back up a storage device. The snapshot technique includes snapshot technique for a file system (a file system snapshot), snapshot technique for an application software program (for example, a database snapshot), etc.

A file system snapshot is a technique to record the PPI (persistent_point-in-time) of the file system. An example of the file system snapshot maybe a volume shadow copy service implemented in Windows (registered trademark). Windows is one of the OSs (operating systems). In the descriptions below, the application software program is referred to as “application”.

When the file system snapshot is performed, the file and the directory on a file system may be recorded (stored) in a moment. A file system is to manage data recorded on a storage device. A technique using the snapshot is described below.

As a first technique, client data at a certain time point is protected at a single time point using a single snapshot. As a second technique, using one or more application writers (for example, through the volume shadow copy service), a snapshot may be generated. The snapshot has the consistency between one or more physical machine volumes and an application (and/or file system).

Patent Document 1: Japanese Laid-open Patent Publication No. 2008-545198

Patent Document 2: Japanese Laid-open Patent Publication No. 2009-536762

### SUMMARY

The information processing device according to an aspect of the present embodiment includes a storage unit which stores information, and a processor which performs processes including generating a first snapshot of the information, and storing first pointer information indicating a storage position of the information associated with the first snapshot in the storage unit, monitoring completion of a writing process on the information when the first snapshot is generated during the writing process, generating a second snapshot of the information when the completion of the writing process is detected, and storing, in the storage unit, second pointer information indicating a storage position of the information associated with the second snapshot; and replacing the first pointer information stored in the storage unit with the second pointer information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of the flowchart of executing a snapshot;

FIG. 2 is an example of the flowchart of executing a snapshot using an API;

FIG. 3 is an example of an information processing device according to the present embodiment;

FIG. 4 is an example of an information processing device according to the first embodiment;

FIGS. 5A through 5C are explanatory views (1) of generating a snapshot according to the first embodiment of the present invention;

FIGS. 6A through 6D are explanatory views (2) of generating a snapshot according to the first embodiment of the present invention;

FIGS. 7A through 7C are explanatory views (3) of generating a snapshot according to the first embodiment of the present invention;

FIG. 8A is an example of a flowchart (1) of executing the snapshot according to the first embodiment of the present invention;

FIG. 8B is an example of a flowchart (2) of executing the snapshot according to the first embodiment of the present invention;

FIG. 9 is an example of an information processing device according to the second embodiment of the present invention;

FIG. 10A is an example of a flowchart (1) of executing the snapshot according to the second embodiment of the present invention;

FIG. 10B is an example of a flowchart (2) of executing the snapshot according to the second embodiment of the present invention; and

FIG. 10C is an example of a flowchart (3) of executing the snapshot according to the second embodiment of the present invention.

### DESCRIPTION OF EMBODIMENTS

When the file is being written at the time of generating a snapshot, the backup data generated by the snapshot may be broken.

Then, according to an aspect of the present embodiment, the technique of improving the integrity of the data obtained by the snapshot is provided.

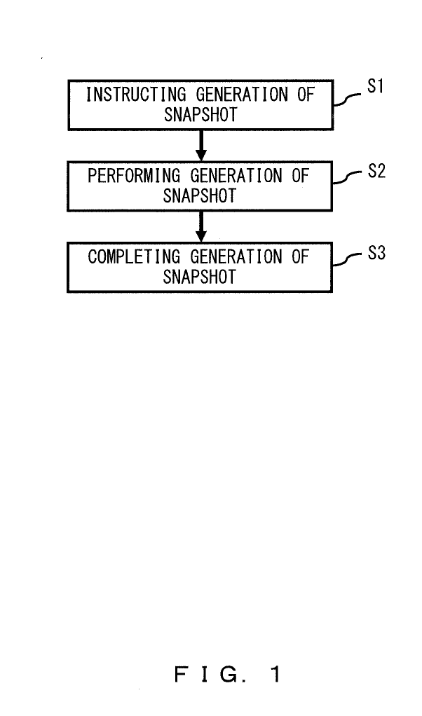

FIG. 1 is an example of the flowchart of executing a snapshot. In the information processing device, when the execution of a file system snapshot is specified (S1), the control unit of the information processing device generates a snapshot (S2, S3).

However, when the writing process on the file and the acquisition of the snapshot match in timing, the snapshot may be recorded (stored) during the writing state depending on the file system. The state of writing on the file is hereafter referred to as a crash inconsistent state. The crash inconsistent state is avoided by the specification of a file system in the file system of, for example, a UNIX-based system.

For example, in the Windows (registered trademark) file system, there are a number of information processing system in which a backup operation is performed using the volume shadow copy service (VSS). The VSS is a technique to back up a snapshot by temporarily generating a snapshot (shadow copy). However, in the information processing system, there may occur the crash inconsistent state.

The occurrence of the crash inconsistent state with the VSS refers to an operation of a specification, and the VSS and the backup software using the VSS is not to detect a crash inconsistent state.

Therefore, in the above-mentioned system, there is the possibility that a backup file in the crash inconsistent state is included. Accordingly, it is not recognized that a file has been destroyed before the backup data is restored. Since data is rarely restored for each system, there are a number of systems in which the backup operation is performed with a problem included. It is a serious risk for a system to detect the problem in the restoring and disaster recovery scene after a system crash.

Therefore, for example, in the Windows (registered trademark) file system, it is considered that the problem may be avoided by waiting for the execution of a writing process by calling the API (application program interface) by an application which performs the writing process.

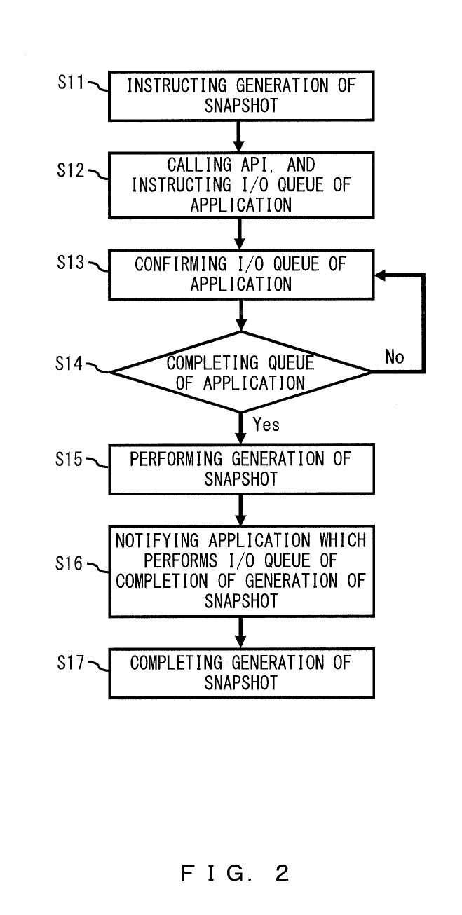

FIG. 2 is an example of the flowchart of executing a snapshot using an API. In the information processing device, an instruction to perform a file system snapshot is issued (S11). Then, the control unit of the information processing device calls the API, and instructs the application to wait for the input/output process (I/O queue) (S12). When the control unit confirms the queue of the I/O of the application (S13, S14), it generates a snapshot (S15).

After generating a snapshot, the control unit notifies the application which has waited for the I/O that the snapshot has been completely generated (S16). Thus, the generation of the snapshot is completed.

However, it is not practical for user to select each application implemented with an API call. Therefore, the occurrence of the crash inconsistent state is an event that may occur on the Windows (registered trademark) file system. In addition, even though each application is implemented with an API call, a large number of APIs may be called upon record of a snapshot, which may cause an overload to the system.

The technique of improving the integrity of backup data without an API in a snapshot is described below according to the present embodiment.

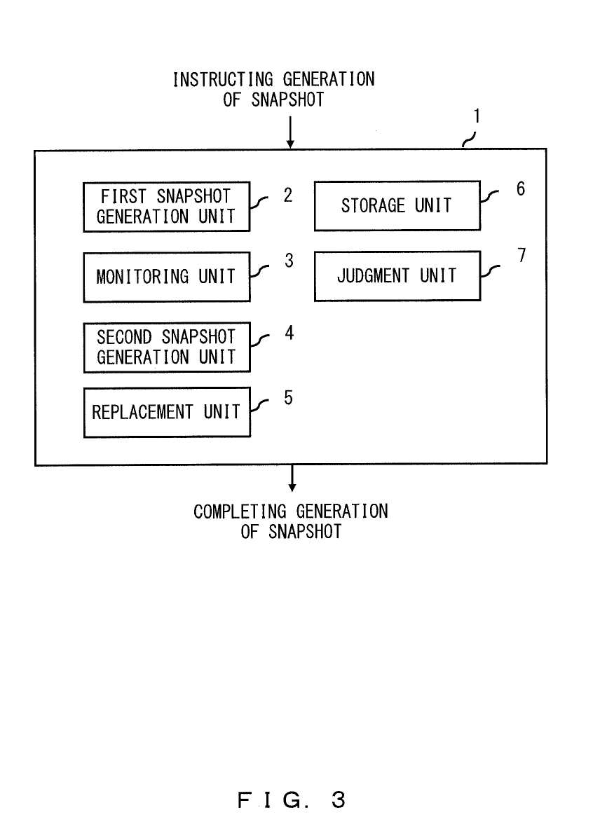

FIG. 3 is an example of an information processing device according to the present embodiment. An information processing device 1 includes a first snapshot generation unit 2, a monitoring unit 3, a second snapshot generation unit 4, a replacement unit 5, and a storage unit 6.

The storage unit 6 stores information. An example of the storage unit 6 may be an HDD 21 or a volume 22.

the first snapshot generation unit 2 generates the first snapshot about the information, and stores the first pointer information indicating the storage position of the information associated with the first snapshot in the storage unit 6. As example of the first snapshot generation unit 2 is a generation unit 16.

The monitoring unit 3 monitors the end of the writing operation when the first snapshot is generated while the writing process on the information is being performed. That is, the monitoring unit 3 continuously acquires the write state information indicating that the writing process on the information is being performed, and judges that the write state information corresponding to the information has been released when the write state information is not acquired. An example of the monitoring unit 3 may be a monitoring unit 17. A file handle is an example of the write state information.

When the monitoring unit detects the end of the writing operation, the second snapshot generation unit 4 generates the second snapshot about the information, and stores the second pointer information indicating the storage position of the information associated with the second snapshot in the storage unit 6. The generation unit 16 may be an example of the second snapshot generation unit 4.

The replacement unit 5 replaces the first pointer information stored in the storage unit 6 with the second pointer information. A replacement unit 19 may be an example of the replacement unit 5.

With the configuration above, the integrity of the data acquired by the snapshot may be improved.

The information processing device 1 may further include a judgment unit 7. The judgment unit 7 judges whether or not there is a difference between the generated second snapshot and the information stored in the storage unit 6. A collation unit 18 maybe an example of the judgment unit 7. Thus, it is confirmed that no crash inconsistent state has occurred in the second snapshot.

If it is judged that there is no difference between the generated second snapshot and the information stored in the storage unit 6, then the replacement unit 5 performs the following process. That is, the replacement unit 5 replaces the first pointer information stored in the storage unit 6 with the second pointer information, and deletes the second snapshot.

Further described below is the present embodiment.

### First Embodiment

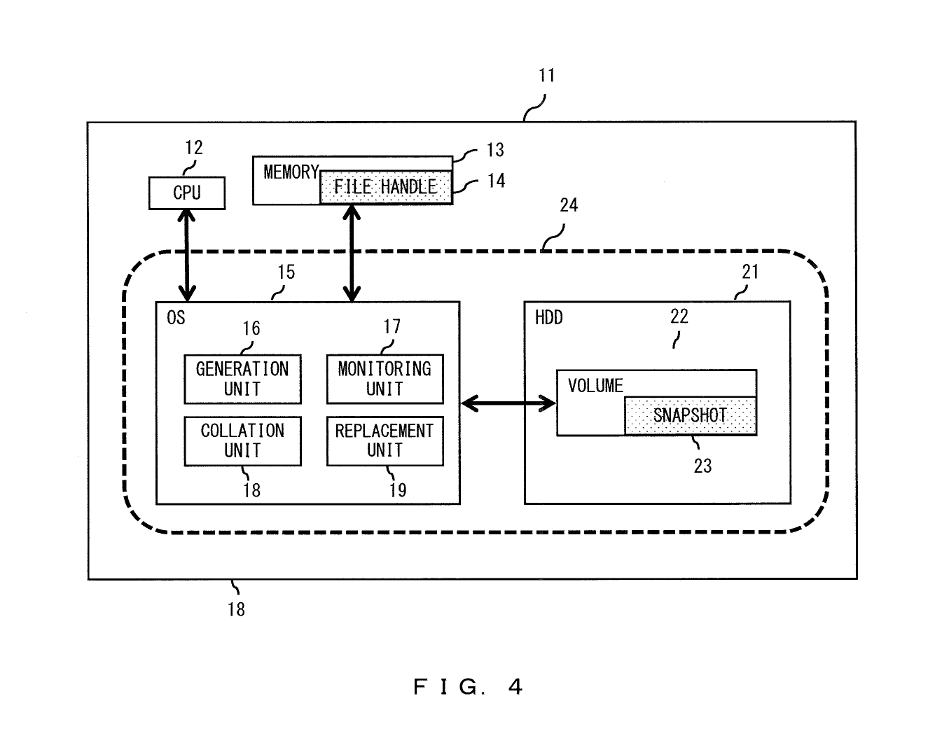

FIG. 4 is an example of an information processing device according to the first embodiment. An information processing device 11 includes a central processing unit (CPU) 12, memory 13, an OS 15, and a hard disk drive (HDD) 21.

The HDD 21 stores a program, data, etc. of an OS, an application, etc. The HDD 21 includes one or more volumes. A volume refers to a management unit of a storage device.

The CPU 12 reads the program of the OS 15 which is stored in the HDD 21, and executes the program of the OS 15. The memory 13 temporarily stores the information.

The OS 15 includes the generation unit 16, the monitoring unit 17, the collation unit 18, and the replacement unit 19. When the CPU 12 executes the program of the OS 15, it may function as the generation unit 16, the monitoring unit 17, the collation unit 18, and the replacement unit 19.

A file system 24 is represented by the OS 15 and the HDD 21 (volume 22). The file system 24 manages a file/directory. For example, the file system 24 manages the pointer as it generates, changes, and deletes a file/directory. A pointer refers to the information about the storage position of a file in the file system 24, the HDD 21, or the volume 22, and is stored in the HDD 21.

The generation unit 16 generates a snapshot 23 of the volume 22 of the HDD 21. The generation unit 16 generates a snapshot (basic snapshot) 23 at a time point, and then generates again a snapshot (restored snapshot) depending on the below-described monitoring result of the monitoring unit 17. According to the present embodiment, the generated snapshot 23 is stored in the HDD 21 (for example, the volume 22).

If a write occurs on a file included in the basic snapshot when the basic snapshot is generated, the monitoring unit 17 stores a file handle 14 corresponding to the file in which the write has occurred in the memory 13 and monitors it. The file handle 14 is the information indicating that an operation of writing/reading is being performed on a file. Thus, the monitoring unit 17 may monitor whether or not the file handle 14 which has existed when the basic snapshot was generated has been released, whether or not it is doubtful that the restored snapshot is in the crash inconsistent state, etc. When the monitoring unit 17 detects that a file is processed in the writing/reading operation etc. by the file handle 14, the file is registered as a file to be monitored in the file handle list described later. The file handle list is used in managing a file which is processed in the writing operation etc. when the basic snapshot is generated as a file to be managed.

The monitoring unit 17 may monitor a file handle at a specified interval, or may monitor a file handle with arbitrary timing. As for the implementation, a timeout value (n times) maybe set for the monitoring by considering the case in which the file handle 14 of a file to be monitored is not released. The character n is any integer.

When the monitoring unit 17 judges that there is no file handle 14 for a file to be monitored, the generation unit 16 generates a restored snapshot as described above.

The replacement unit 19 replaces a file/directory pointer of a file to be monitored in the basic snapshot with a file/directory pointer of a file to be monitored in the restored snapshot. Then, the replacement unit 19 deletes the restored snapshot.

Thus, when a snapshot at a certain time point is acquired, the file being written at the time point may be replaced with the information about the file at the time point when the writing operation is completed. As a result, the integrity of the data acquired in the snapshot maybe improved.

In addition, to improve the integrity of the data acquired in the snapshot, the replacement unit 19 may make a replacement after judging whether or not there has occurred a crash inconsistent state in the restored snapshot. It is described below in detail.

When the monitoring unit 17 judges that there is no file handle 14 of a file to be monitored, the collation unit 18 collates the restored snapshot with the data of the actual file/directory corresponding to the restored snapshot. If there is a difference in the collated data, the collation unit 18 judges that there has occurred a crash inconsistent state in the restored snapshot. If there is no difference in the collated data, the collation unit 18 judges that there has occurred no crash inconsistent state in the restored snapshot.

When there has occurred no crash inconsistent state in the restored snapshot, the replacement unit 19 performs the following process. That is, the replacement unit 19 replaces the file/directory pointer of the file to be monitored in the basic snapshot with the file/directory pointer of the file to be monitored in the restored snapshot. Then, the replacement unit 19 deletes the restored snapshot.

Thus, the integrity of the data acquired in the snapshot may be further improved.

The program which functions as the generation unit 16, the monitoring unit 17, the collation unit 18, and the replacement unit 19 may be recorded on a portable recording medium such as CD-ROM, a DVD, Blu-ray, IC memory, a flexible disk, etc. In this case, the CPU 12 reads the program from the portable recording medium, and executes the program.

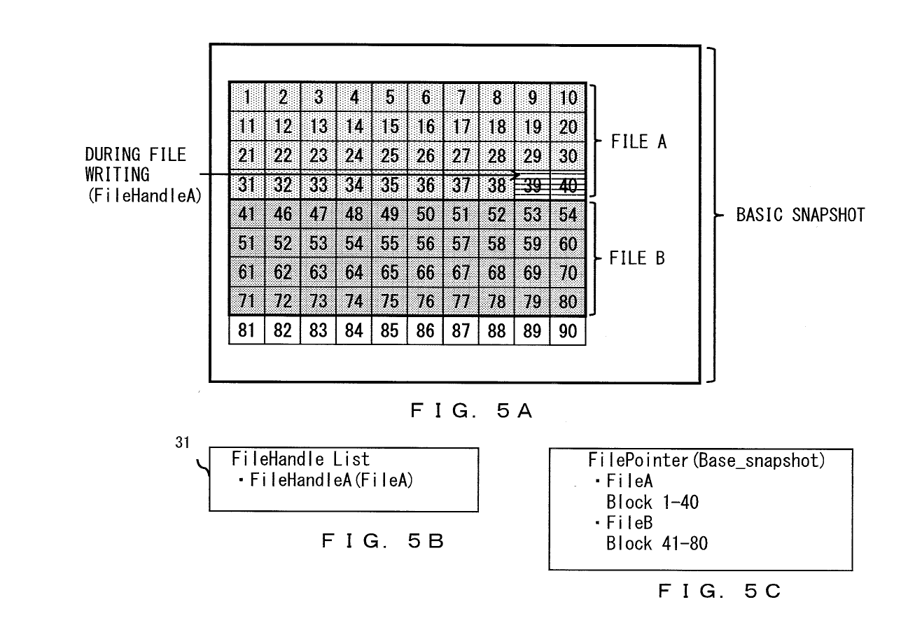

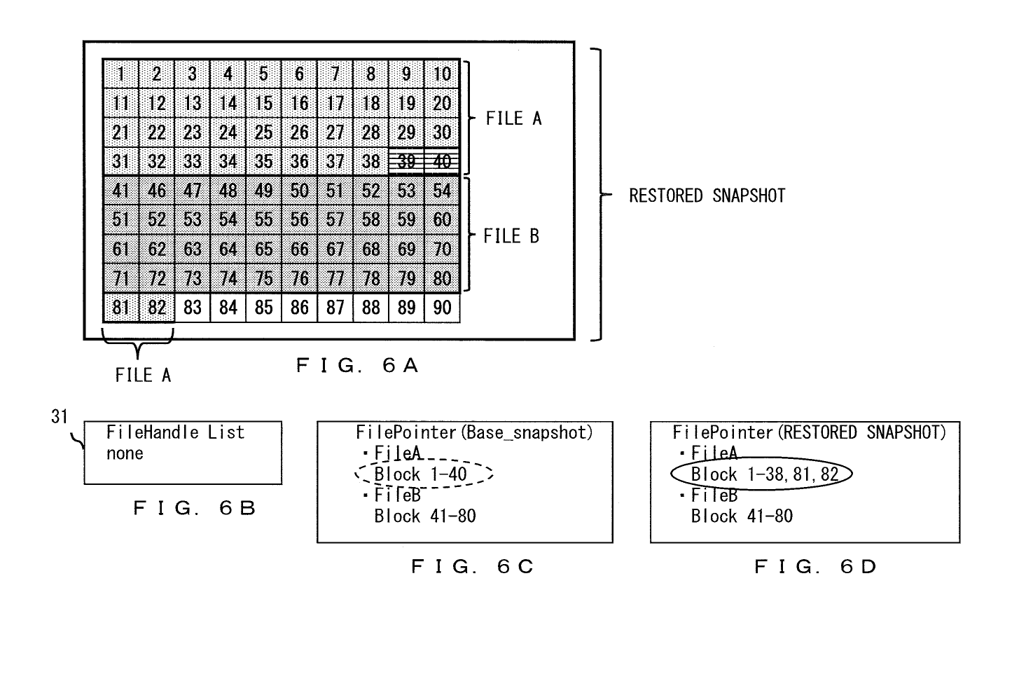

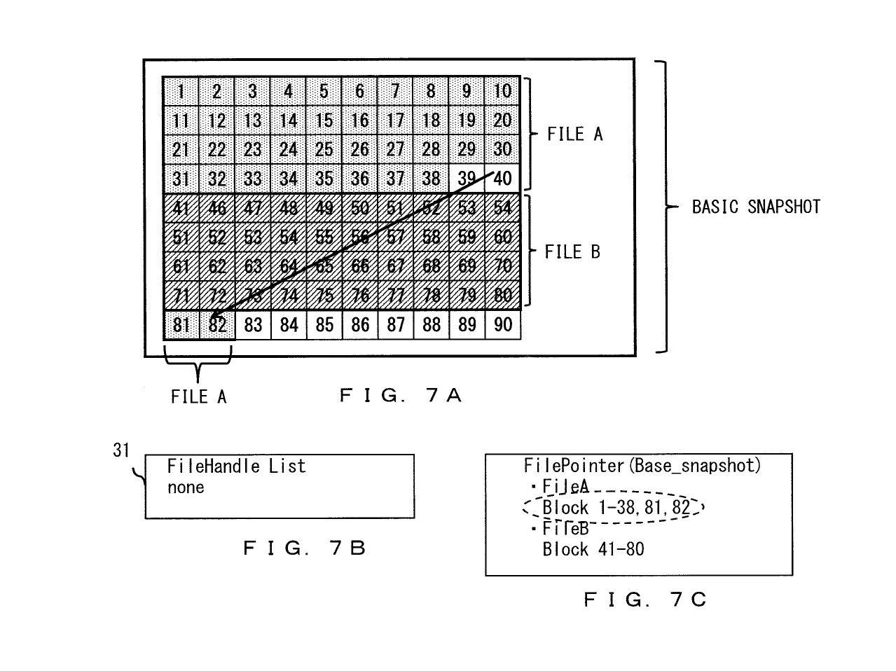

FIGS. 5A through 5C are explanatory views of generating a basic snapshot according to the first embodiment of the present invention. FIGS. 6A through 6D are explanatory views of generating a restored snapshot according to the first embodiment of the present invention. FIGS. 7A through 7C are explanatory views of completing the generation of a snapshot according to the first embodiment of the present invention. FIGS. 5A, 6A, and 7A are examples of the block of a target area of a snapshot in the volume 22 of the file system 24. FIGS. 5B, 6B, and 7B are examples of a file handle list. FIGS. 5C, 6C, and 7C are examples of file pointer information included in a basic snapshot. FIG. 6D is an example of file pointer information included in a restored snapshot.

In FIG. 5A, for example, there is a storage area indicated by blocks 1 through 90 in the volume 22 of the file system 24. A file A includes file data stored in the blocks 1 through 40. A file B includes file data stored in the blocks 41 through 80.

In FIG. 5A, the blocks 39 and 40 of the file A is in the writing state. In this case, it is recognized that the file A is being written by the file handle A.

The generation unit 16 generates a snapshot (basic snapshot) in a target area as illustrated in FIG. 5A. FIG. 5C illustrates the file pointer information (blocks 1 through 40) of the file A included in the basic snapshot, and the file pointer information (blocks 41 through 80) of the file B. In this case, the generation unit 16 places the block storing a file in a write disabled state. Therefore, the writing operation on the blocks 1 through 40 for the file A and on the blocks 41 through 80 for the file B is limited.

The blocks 39 and 40 being written while a snapshot is generated are in the crash inconsistent state. In this case, the monitoring unit 17 registers the information indicating the write of the file A in a file handle list 31 while a basic snapshot is being generated as illustrated in FIG. 5B.

As described above, the write to the blocks 1 through 40 for the file A and the blocks 41 through 80 for the file B is limited. Therefore, the information to be written to the blocks 39 and 40 is written to the blocks not write-restricted, for example, to the blocks 81 and 82 under the control of the file system 24 as illustrated in FIG. 6A.

The monitoring unit 17 monitors whether or not the file handle of the file to be monitored and registered in the file handle list 31 has been released. As a result of the monitoring, when the writing process on the file A is completed (that is, when the file handle of the file to be monitored is released), the monitoring unit 17 notifies the generation unit 16 that the file handle has been released. In this case, the monitoring unit 17 deletes the information indicating that the file A has been written from the file handle list 31 as illustrated in FIG. 6B.

When the generation unit 16 receives a notification that the file handle of the file to be monitored has been released, it regenerates a snapshot (restored snapshot) in a target area as illustrated in FIG. 6A. FIG. 6D illustrates the information about the file pointer of the file A and the file pointer of the file B included in the restored snapshot.

After generating the restored snapshot, the monitoring unit 17 confirms again the file handle before the process performed by the replacement unit 19 described later.

If it is judged that there is no file handle, the collation unit 18 may perform the following process. That is, the collation unit 18 collates the restored snapshot with the data of the actual file/directory on the file system 24 corresponding to the restored snapshot. If there is no difference between the restored snapshot and the data of the actual file/directory on the file system 24 as a result of the collation, then the collation unit 18 judges that the restored snapshot is not in the crash inconsistent state.

After the generation of the restored snapshot by the generation unit 16, or after the collation by the collation unit 18, the replacement unit 19 performs the following process. That is, the replacement unit 19 replaces the file/directory pointer (FIG. 6C) of the file to be monitored in the basic snapshot with the file/directory pointer (FIG. 6D) of the file to be monitored in the restored snapshot. FIG. 7C illustrates the resultant pointer indicating the file/directory (file A) of the file to be monitored in the basic snapshot.

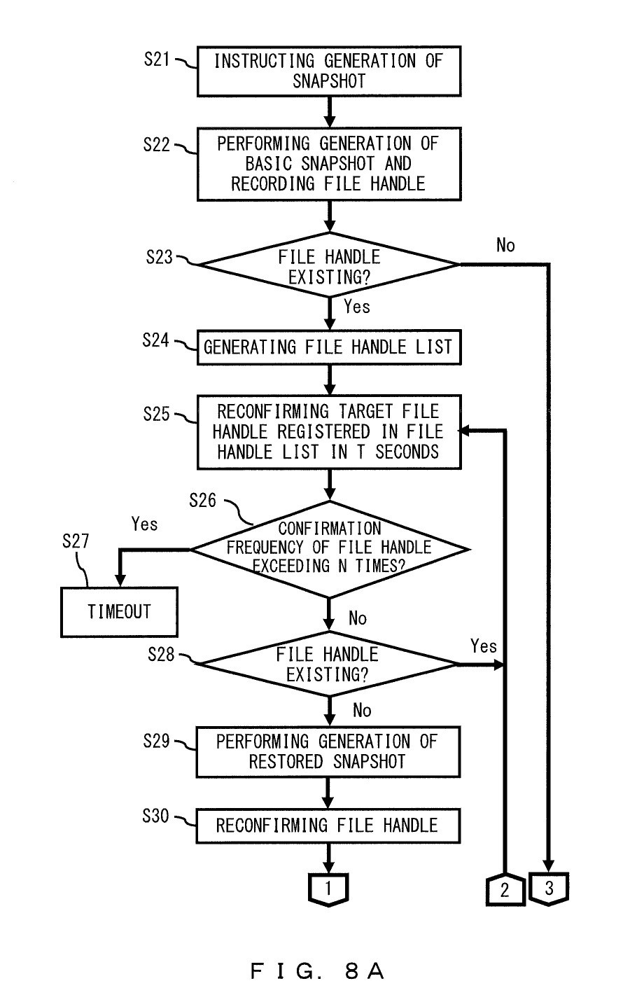

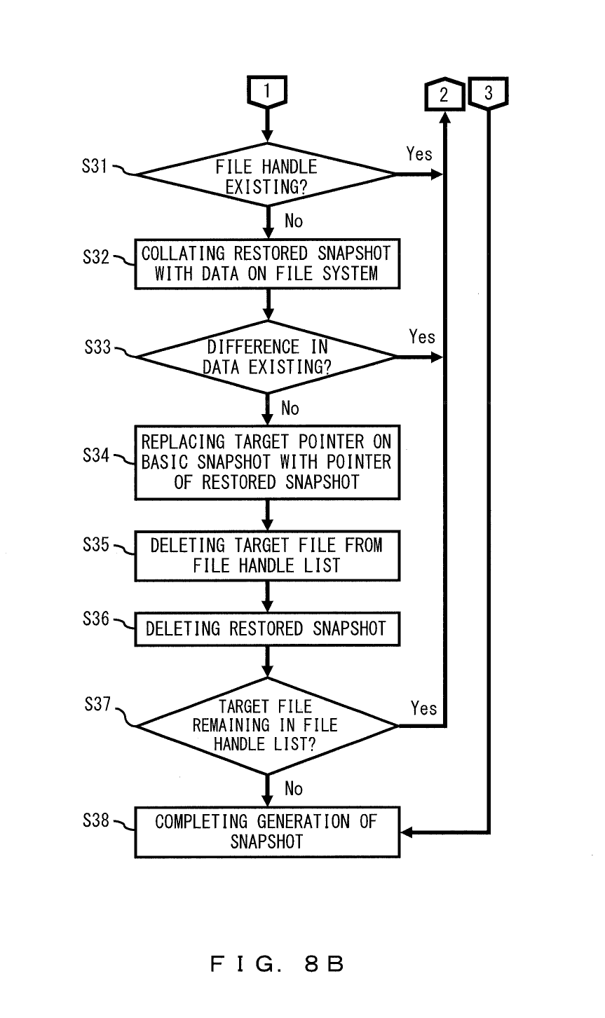

FIGS. 8A and 8B are examples of flowcharts of executing the snapshot according to the first embodiment of the present invention. The CPU 12 which executes the OS 15 receives an instruction to generate a snapshot according to a user instruction or an application (S21). Then, the CPU 12 functions as the generation unit 16, the monitoring unit 17, the collation unit 18, and the replacement unit 19 as described below.

The generation unit 16 generates a snapshot (basic snapshot) in the area (for example, a volume) as a target of a snapshot in the volume 22, and stores it in the volume 22 of the HDD 21. In this case, the monitoring unit 17 detects a file handle managed by the file system 24, and records the detected file handle in the memory 13 (S22).

In S22, if the file included in the basic snapshot is not being written while generating the basic snapshot, that is, if no file handle is recorded (“NO” in S23), then the generation of the snapshot is completed (S38).

In S22, if the file included in the basic snapshot is being written while generating the basic snapshot, that is, file handle is recorded in the memory 13 (“YES” in S23), then the monitoring unit 17 performs the following process. That is, the monitoring unit 17 generates the file handle list 31 (S24). In the files included in the basic snapshot, the information for identification of the file (file to be monitored) being written while generating a basic snapshot is registered in the file handle list 31.

In t (any real number) seconds, the monitoring unit 17 detects a file handle from the file system 24. Then, the monitoring unit 17 judges whether or not the file indicated by the detected file handle is in the file handle list 31 (S25). That is, the monitoring unit 17 judges whether or not the file handle of the file to be monitored has been released.

When the frequency of the file handle confirming process in S25 exceeds n (any integer) (“YES” in S26), a timeout occurs (S27). When a timeout occurs, the monitoring unit 17 records the information that the file handle of a file to be monitored has not been released (information that there is a possibility of the crash inconsistent state) in the header of the file to be monitored.

When the frequency of the file handle confirming process in S25 does not exceed n (any integer) (“NO” in S26), and if the file handle of the file to be monitored has not been released (“YES” in S28), then process is returned to S25.

When the file handle of the file to be monitored is released (“NO” in S28), the generation unit 16 generates a snapshot again (restored snapshot), and stores it in the HDD 21 (S29).

The monitoring unit 17 judges again whether or not there is a file handle of a file to be monitored in the file system 24 (S30). If there is a file handle in S30 (“YES” in S31), process is returned to step S25.

If there is no file handle in S30 (“NO” in S31), the collation unit 18 collates the restored snapshot with the data on the file system 24 corresponding to the restored snapshot (S32). As a result of the collation, if there is a difference between the restored snapshot and the data on the file system (“YES” in S33), then process is returned to S25.

If there is no difference as a result of the collation between the restored snapshot and the data on the file system (“NO” in S33), the replacement unit 19 performs the following process. That is, the replacement unit 19 replaces the file/directory pointer of the file to be monitored in a basic snapshot with the file/directory pointer of the file to be monitored in a restored snapshot (S34).

The replacement unit 19 deletes the information designating the file to be monitored from the file handle list 31 (S35). The replacement unit 19 deletes the restored snapshot from the HDD 21 (S36).

The monitoring unit 17 judges whether or not there is still another file to be monitored in the file handle list 31 (S37). If there is any file to be monitored in the file handle list 31 (“YES” in S37), process is returned to S25. If there is no file to be monitored in the file handle list 31 (“NO” in S37), then the generation of a snapshot is terminated (S38).

FIGS. 8A and 8B illustrate an example of the flowchart of performing a snapshot when the collating process is performed by the collation unit 18 after generating a restored snapshot. However, depending on the specification, process may be passed to S34 when “NO” in S31.

According to the present embodiment, when a snapshot is recorded, there is a possibility that a data stationary point in the snapshot is not constant. However, since the generation of a crash inconsistent state indicates the destruction of data, the integrity of data acquired in a snapshot may be improved according to the above embodiment. Therefore, although the timing of recording a file system snapshot and the write timing to data overlap, a snapshot may be generated without data inconsistency. Furthermore, according to the present embodiment, no API is to be generated for each application.

### Second Embodiment

In the second embodiment, the I/O queue process by an API is shared with the first embodiment as described below.

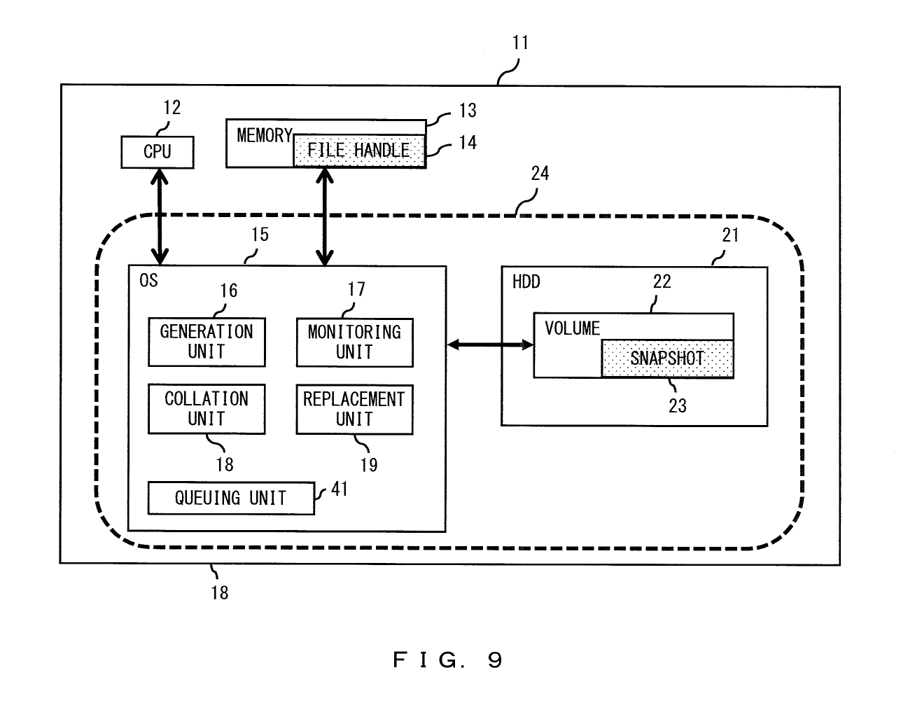

FIG. 9 is an example of an information processing device according to the second embodiment of the present invention. The information processing device 11 in FIG. 9 is obtained by adding a queuing unit 41 to the information processing device 11 in FIG. 4.

If an API is incorporated into an application, the queuing unit 41 places the I/O of the application in a wait state while a snapshot is being generated.

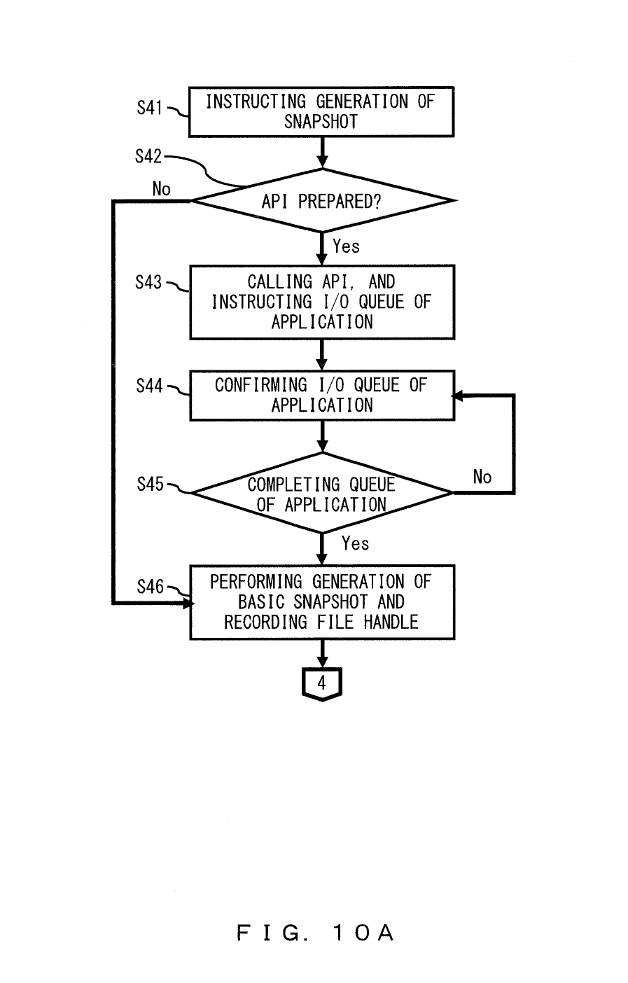

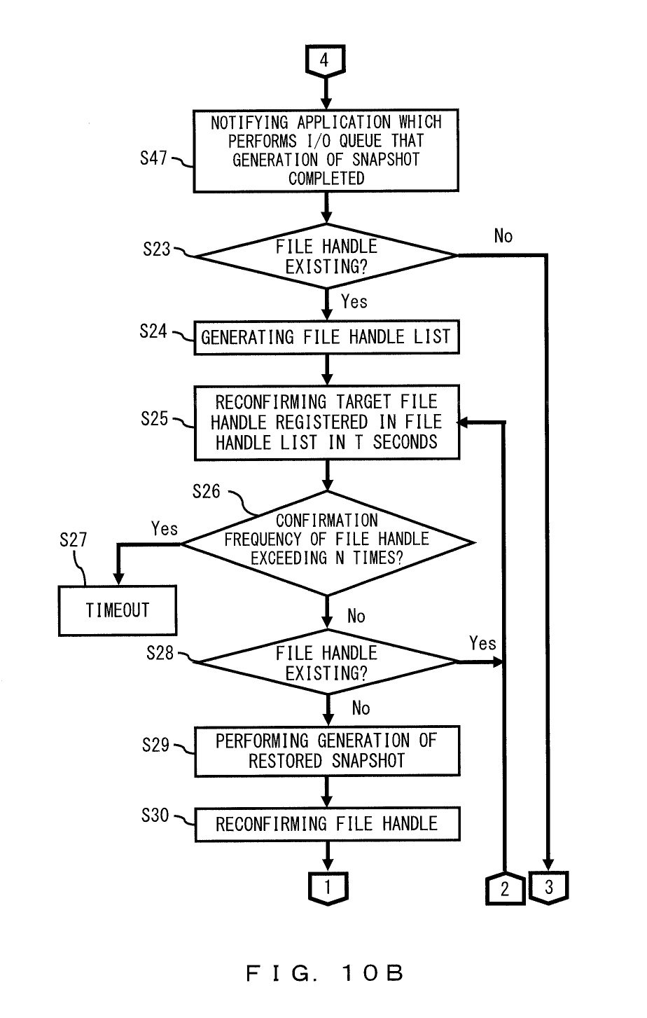

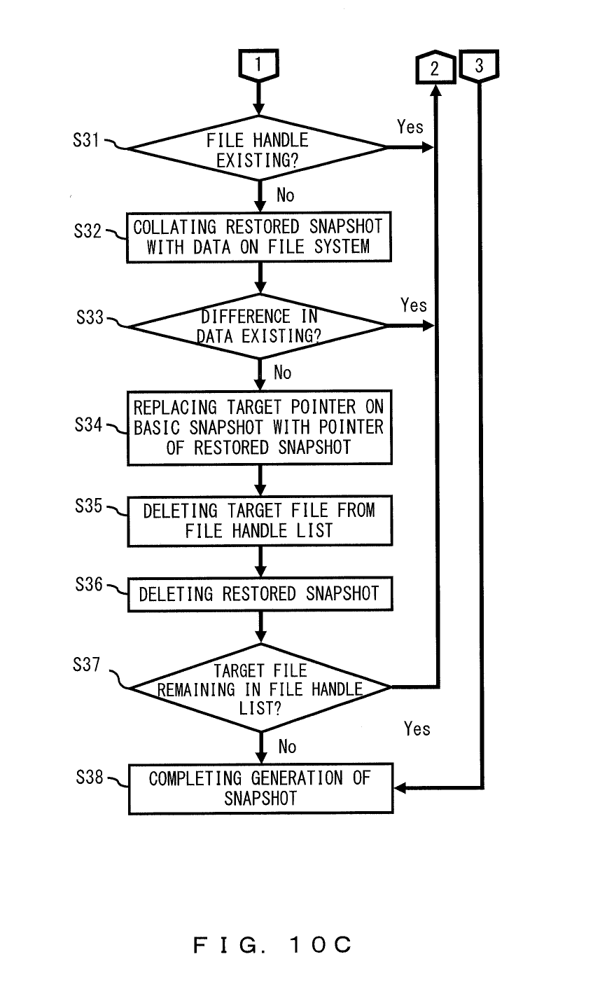

FIGS. 10A, 10B, and 10C are examples of flowcharts of executing a snapshot according to the second embodiment. The CPU 12 which executes the OS 15 receives an instruction to generate a snapshot from a user or an application (S41). Then, the CPU 12 functions as the generation unit 16, the monitoring unit 17, the collation unit 18, the replacement unit 19, and the queuing unit 41 as described below. If there is no application implemented with an API call (“NO” in S42), process is passed to S46.

When there is an application implemented with an API call (“YES” in S42), the queuing unit 41 calls the API, and instructs the application to wait for the input/output process (I/O) (S43). The queuing unit 41 completes the queue of the I/O of the application (S44, S45).

Then, the generation unit 16 generates the snapshot (basic snapshot) of the target volume in the file system 24, and stores it in the volume 22 of the HDD 21. In this case, the monitoring unit 17 records in the memory 13 the file handle in the volume 22 of the file system 24 (S46). The process in S46 is the same as that in S22 in FIG. 8A. Since the processes in and after S46 are the same as those in and after S22 in FIGS. 8A and 8B, the explanation is omitted here.

The present embodiment is not limited to the embodiments above, but various configurations and embodiments may be realized within the scope of the gist of the present embodiment.

According to an aspect of the present embodiment, the integrity of the data acquired in a snapshot may be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a storage unit which stores information; and
a processor which performs processes including:
generating a first snapshot of the information, and storing first pointer information indicating a storage position of the information associated with the first snapshot in the storage unit;
monitoring completion of a writing process on the information when the first snapshot is generated during the writing process;
generating a second snapshot of the information when the completion of the writing process is detected, and storing, in the storage unit, second pointer information indicating a storage position of the information associated with the second snapshot; and
replacing the first pointer information stored in the storage unit with the second pointer information.

2. The device according to claim 1, wherein
when the completion of the writing process is monitored, write state information indicating that writing process is performed on the information is continuously acquired, and when the write state information is not acquired, the write state information corresponding to the information is judged to have been released.

3. The device according to claim 1, wherein:
the processes further include a process of
judging whether or not there is a difference between the generated second snapshot and the information stored in the storage unit; and
when the generated second snapshot and the information stored in the storage unit are judged to have no difference, the first pointer information stored in the storage unit is replaced with the second pointer information, and the second snapshot is deleted.

4. A computer-readable recording medium having stored therein a program for causing a computer to execute a process for generating a snapshot, the process comprising:
generating a first snapshot of information stored in a storage unit which stores the information, and storing first pointer information indicating a storage position of the information associated with the first snapshot in the storage unit;
monitoring completion of a writing process on the information when the first snapshot is generated during the writing process;
generating a second snapshot of the information when the completion of the writing process is detected, and storing, in the storage unit, second pointer information indicating a storage position of the information associated with the second snapshot; and
replacing the first pointer information stored in the storage unit with the second pointer information.

5. The medium according to claim 4, wherein
when the completion of the writing process is monitored, write state information indicating that writing process is performed on the information is continuously acquired, and when the write state information is not acquired, the write state information corresponding to the information is judged to have been released.

6. The medium according to claim 4, the processes further comprising:
judging whether or not there is a difference between the generated second snapshot and the information stored in the storage unit; and
when the generated second snapshot and the information stored in the storage unit are judged to have no difference, the first pointer information stored in the storage unit is replaced with the second pointer information, and the second snapshot is deleted.

7. A method for generating a snapshot, the method comprising:
generating by a computer a first snapshot of information stored in a storage unit which stores the information, and storing first pointer information indicating a storage position of the information associated with the first snapshot in the storage unit;
monitoring, by the computer, completion of a writing process on the information when the first snapshot is generated during the writing process;
generating by the computer a second snapshot of the information when the completion of the writing process is detected by the monitoring unit, and storing, in the storage unit, second pointer information indicating a storage position of the information associated with the second snapshot; and
replacing by the computer the first pointer information stored in the storage unit with the second pointer information.

8. The method according to claim 7, wherein
when the completion of the writing process is monitored, write state information indicating that writing process is performed on the information is continuously acquired by the computer, and when the write state information is not acquired, the write state information corresponding to the information is judged by the computer to have been released.

9. The method according to claim 7, the method further comprising:
judging by the computer whether or not there is a difference between the generated second snapshot and the information stored in the storage unit; and
when the generated second snapshot and the information stored in the storage unit are judged to have no difference, by the computer, the first pointer information stored in the storage unit is replaced with the second pointer information, and the second snapshot is deleted.
